(19) United States
(12) Patent Application Publication
(10) Pub. No.: US 2008/0178095 A1
(43) Pub. Date: Jul. 24, 2008

(54) Method Of Changing Idle Screen Template Type Of Mobile Communication Termianl, Computer Readable Recording Medium In Which Program For Executing The Same Is Recorded And Mobile Communication Terminal Having Function Thereof

(76) Inventor: Chang Seok Lee, Seoul (KR)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 11/910,347

(22) PCT Filed: Nov. 21, 2005
(86) PCT No.: PCT/KR2005/003932

§ 371 Date: Oct. 1, 2007

(30) Foreign Application Priority Data
Jan. 1, 2005 (KR) 10-2005-0027694

(51) Int. Cl. G06F 3/048

(52) U.S. Cl. 715/747

(57) ABSTRACT

The present invention relates to a mobile communication terminal having an idle screen function, and more particularly, to a method of changing idle screen templates of the mobile communication terminal. A method of changing an idle screen template type of a mobile communication terminal according to the present invention comprising the steps of (a) selecting any one of template types that has been previously set to display the selected template type on an idle screen of the mobile communication terminal, (b) configuring a channel according to the selected template type, (c) changing a template type that is already displayed to a changed template type in accordance with the template type in which the channel is configured and (d) displaying the changed template type on the idle screen.

### TECHNICAL FIELD

The present invention relates to a mobile communication terminal having an idle screen function, and more particularly, to a method of changing idle screen templates of the mobile communication terminal.

### BACKGROUND ART

With the development of wireless Internet services, service providers have offered user-oriented information services. The offering of such services has lead to the popularization of the wireless Internet.

In a conventional wireless Internet service system, information is transmitted to a user in a Short Message Service (SMS) form. Information received by way of SMS is stored as a simple message in a mobile communication terminal apparatus. As a result, multimedia information such as financial information and entertainment banners cannot consistently displayed to a user.

In current wireless Internet service systems, the use of multimedia information has increased given the adoption of a color screen for the mobile communication terminal, high specification of the mobile communication terminal, an increased speed of the wireless Internet and the like.

In the related arts, the user could not select the information to be received, but rather could only view information selected by the service provider. Therefore, a problem arises because a user cannot select the financial information and entertainment information they want to view.

In the related arts, a limited amount of data could be transmitted at one time using an SMS service. As such audio or video data could not be transmitted to a user.

The prior art information transmission services using SMS are adapted to simply transfer information. Such services are problematic as they do not provide a user with interaction through which the user can gain access to a related wireless Internet site through a hyperlink function.

In the prior art information transmission services, a user has to acquire information through direct access using an Internet access application or a browser built into a mobile communication terminal. Information specific to a user could not be provided.

To solve the aforementioned problems, there has been proposed Korean Patent Registration No. 391291, which was filed by the applicant of the present invention.

In the above patent, information content to be provided to a mobile communication terminal apparatus is converted into information of a message format, which is suitable for transmission through a mobile communication network. The converted sliding message is then transmitted to the mobile communication terminal apparatus so that a user can confirm the information content.

The Korean Patent Registration No. 391291, however, does not disclose embodiment(s) of a template configuration method for an information providing method, in which information content is displayed.

To solve the above problem, the applicant of the present invention has filed PCT/KR2004/0002097 entitled “APPARATUS AND METHOD FOR CONTROLLING AND OPERATING IDLE SCREEN RESOURCE IN MOBILE COMMUNICATION TERMINAL APPARATUS”.

This patent only discloses a template configuration method and an information providing method relating to the resource and operation of the mobile communication terminal, but does not disclose a change of the idle screen information display in a mobile communication terminal, a web or a Wireless Application Protocol (WAP).

### DISCLOSURE OF INVENTION

### Technical Problem

Accordingly, the present invention has been made in view of the above problems, and it is an object of the present invention to provide a method of configuring an idle screen of a mobile communication terminal to adopt to the information the user selects to view by changing templates of the idle screen in the mobile communication terminal, and a mobile communication terminal having such a function.

It is another object of the present invention is to provide a method of configuring an idle screen of a mobile communication terminal to adapt to user select information by changing the templates of the idle screen in a web or a WAP.

### Technical Solution

To achieve the above objects, a method of changing an idle screen template type of a mobile communication terminal according to the present invention, comprising the steps of (a) accepting a template type which is selected from any one of template types by user, (b) configuring a channel according to the accepted template type, (c) changing a template type in accordance with the accepted template type in which the channel is configured.

According to the present invention, there is provided a computer-readable recording medium in which a program for executing a method of changing an idle screen template type of a mobile communication terminal in a computer, the method comprising the steps of (a) accepting a template type which is selected from any one of template types by user, (b) configuring a channel according to the accepted template type, (c) changing a template type in accordance with the accepted template type in which the channel is configured.

The selection of the template type in the step (a) is performed using a template type change application program within the mobile communication terminal or through a web or a Wireless Application Protocol (WAP).

The template type is changed using the application program, a template type code corresponding to the changed template type is transmitted to a service server and where the template type is changed through the web or WAP, a template type code corresponding to the changed template type is transmitted from the service server to the mobile communication terminal.

In the computer-readable recording medium, the method further comprises the steps of, after the step (b), (b-1) determining whether information content has been set in each of the configured channels, and (b-2) if it is determined that information content has not been set in the step (b-1), setting the desired information content so that the desired information content can be set in a channel.

In the step (b-2), the desired information content can be received from the service server by requesting the desired information content to the service server or can be allocated by selecting the information content that has already been received within the mobile communication terminal.

The information content that is requested to the service server is transmitted as a content code.

The channel included in the selected template type is a sliding region in which characters or images are displayed while being moved or a multimedia region in which images or motion picture is displayed.

A mobile communication terminal in which an idle screen template type can be changed according to the present invention comprising selection means for selecting any one of template types that have been previously set to display the selected template type on an idle screen, channel configuration means for configuring a channel according to the selected template type, template type change means for changing a template type that is already displayed to a changed template type in accordance with the template type in which the channel is configured by the channel configuration means and display means for displaying the changed template type on the idle screen.

The selection of the template type is performed using a template type change application program within the mobile communication terminal or through a web or a WAP.

The template type is changed using the application program, a template type code corresponding to the changed template type is transmitted to a service server and where the template type is changed through the web or WAP, a template type code corresponding to the changed template type is transmitted from the service server to the mobile communication terminal.

The mobile communication terminal may further comprise channel check means for determining whether information content has been set in each of the configured channels and channel allocation means for allocating desired information content so that the desired information content can be set in a channel, if it is determined that information content has not been set by the channel check means.

The desired information content is received from the service server by requesting the desired information content to the service server or allocated by selecting the information content that has already been received within the mobile communication terminal.

Information content that is requested to the service server is transmitted as a content code.

The channel included in the selected template type is a sliding region in which characters or images are displayed while being moved or a multimedia region in which a images or a motion picture are displayed.

A method of adding or deleting an idle screen template type of a mobile communication terminal according to the present invention comprising the steps of (a) adding or deleting template types displayed on an idle screen of the mobile communication terminal, (b) communicating with a service server to add or delete a selected template type and (c) configuring an idle screen of the mobile communication terminal depending on the result of the addition or deletion of the template type, and displaying the configured idle screen. The addition or deletion of the template type in the step (a) is performed using a template type change application program within the mobile communication terminal or through a web or a WAP.

The method may further comprising the steps of, after the step (b), (b-1) determining whether any template type to be added or deleted exists in a service server, and (b-2) after the step (b-1), transmitting template type information, which will be added or deleted in an idle screen template type change program of the mobile communication terminal, to the service server.

The method may further comprising the steps of, after the step (b-2), (b-21) determining whether the deleted template type is a current idle screen template type, and (b-22) configuring the information content so that the information content is allocated to a channel according to the basic template types other than the deleted template type, depending on the result of the step (b-21).

These and other objects of the present application will become more readily apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### ADVANTAGEOUS EFFECTS

The present invention provides a method of changing templates of an idle screen in a mobile communication terminal so that a user can configure the idle screen of the mobile communication terminal to display information selected by the user.

Furthermore, the present invention provides a method of changing templates of an idle screen in a web or a WAP so that a user can configure the idle screen of the mobile communication terminal to display information selected by the user.

### BRIEF DESCRIPTION OF THE DRAWINGS

FIG. 1 is a block diagram of a system for changing idle screen templates of a mobile communication terminal according to the present invention;

FIG. 2 is a flowchart for illustrating a method of changing template types to be displayed on the idle screen of the mobile communication terminal according to the present invention;

FIG. 3 is a flowchart for illustrating a method of adding/deleting template types to be displayed on the idle screen of the mobile communication terminal according to the present invention;

FIG. 4 is a sequence diagram showing a procedure of changing template types using an application program for idle screen provided in the mobile communication terminal according to the present invention;

FIG. 5 is a sequence diagram showing a procedure of changing template types to be displayed on the idle screen of the mobile communication terminal in a web or WAP according to the present invention;

FIG. 6 is a sequence diagram showing a procedure of deleting template types using an application program for idle screen provided in the mobile communication terminal according to the present invention;

FIG. 7 is a sequence diagram showing a procedure of adding template types using an application program for idle screen provided in the mobile communication terminal according to the present invention;

FIG. 8 is a sequence diagram showing a procedure of adding/deleting template types to be displayed on the idle screen of the mobile communication terminal in a web or WAP according to the present invention;

FIG. 9 is a block diagram of a mobile communication terminal including means for changing template types to be displayed on the idle screen of the mobile communication terminal according to the present invention;

FIG. 10 is a block diagram of a mobile communication terminal including means for adding or deleting template types to be displayed on the idle screen of the mobile communication terminal according to the present invention;

FIG. 11 is a block diagram showing basic constituting elements of the idle screen of the mobile communication terminal according to the present invention;

FIGS. 12 to 17 are block diagrams showing template types to be displayed on the idle screen of the mobile communication terminal according to the present invention;

FIG. 18 shows a web screen for changing idle screen template types of the mobile communication terminal according to the present invention;

FIG. 19 shows a web screen for adding/deleting idle screen template types of the mobile communication terminal according to the present invention;

FIG. 20 shows a template setting screen of a WAP or a mobile communication terminal for changing idle screen template types of the mobile communication terminal according to the present invention;

FIGS. 21 to 27 illustrate an example of allocation of content to a channel that has been previously set in idle screen templates type of the mobile communication terminal according to the present invention;

FIG. 28 illustrates an example of deleting idle screen template types of the mobile communication terminal according to the present invention; and

FIG. 29 illustrates an example of adding idle screen template types of the mobile communication terminal according to the present invention.

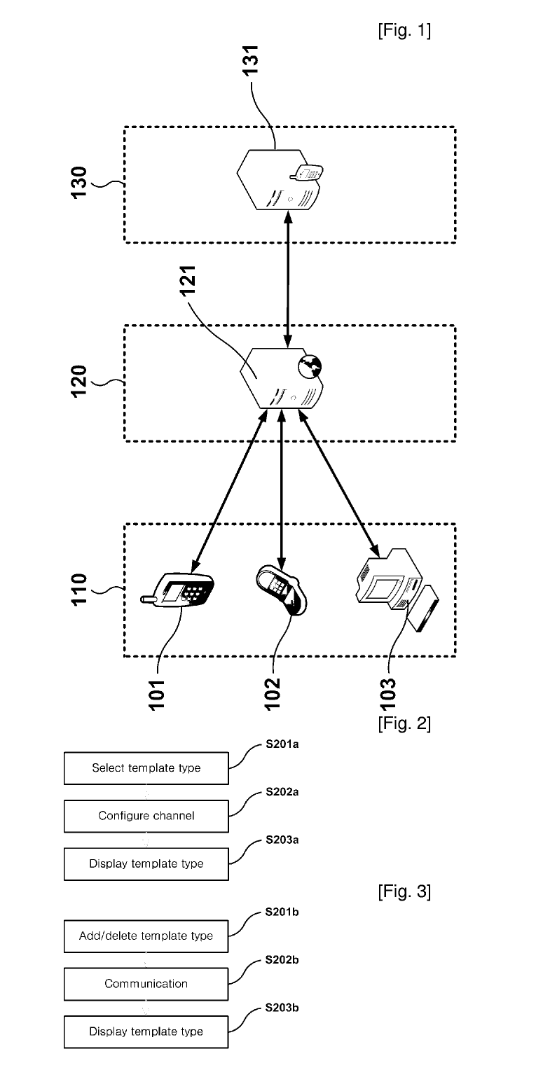

### BEST MODE FOR CARRYING OUT THE INVENTION

The idle screen templates of an idle mode screen set in the client to be modified through a wire Internet, a wireless Internet, etc.

To change an idle screen in a WAP, the system can further comprise a gateway server together with the mobile communication service provider server.

The service server 130 is responsible for a push or a pull service through SMS for setting an idle screen. That is, the client 110 allows a user to change idle screen templates of the mobile communication terminal through SMS using a wire Internet or a wireless Internet.

FIG. 2 is a flowchart for illustrating a method of changing template types to be displayed on the idle screen of the mobile communication terminal according to the present invention. Referring to FIG. 2, a user selects one of template types that have been previously set to display the template type on the idle screen of the mobile communication terminal at step S201a.

The user can select a template type using an application program for controlling the idle screen of the mobile communication terminal, and can select a template type for displaying the idle screen of the mobile communication terminal through a web or a WAP.

If the user selects the template type using the mobile communication terminal, the application program of the mobile communication terminal transmits a template code corresponding to the template type to the service server, which then updates the template code.

Where the template type is selected using the web or the WAP not the mobile communication terminal, the user transmits a template code for the template type that is to be changed, to the service server. The service server updates a template code for each user and pushes the template code for the template type, which has been selected in a web or WAP, to the mobile communication terminal to change the template type of the idle screen of the mobile communication terminal of the user. The mobile communication terminal then updates the template code.

At step S202, the application program for the idle screen of the mobile communication terminal configures a channel depending on the template type. That is, if the user changes the idle screen template type of the mobile communication terminal, the template type is updated in the application program. A channel set in the updated template type is changed accordingly.

Determining whether each channel has been set depends on the changed template type. If the channel has not been set, a message for setting a channel is displayed.

Since the message is displayed as described above, the user can set a channel so that the desired information content can be allocated to the channel. The application program of the mobile communication terminal transmits a content code corresponding to information content to the service server.

The service server can update a code for the information content in the mobile communication terminal.

The service server configures a channel depending on a template type to be displayed on the idle screen of the mobile communication terminal. The service server forms information content for the configured channel as characters in SMS form and pushes the information content to the mobile communication terminal.

Through a series of these processes, a template type to be displayed on the idle screen of the mobile communication terminal is changed and displayed at step S204.

FIG. 3 is a flowchart for illustrating a method of adding/deleting template types to be displayed on the idle screen of the mobile communication terminal according to the present invention.

Referring to FIG. 3, a user newly adds a template that will be displayed on the idle screen of the mobile communication terminal or selects a template type to delete a template type that has been previously set at S201b.

The user can add/delete a template type using an application program for controlling the idle screen of the mobile communication terminal and can add/delete a template type that will be displayed on the idle screen of the mobile communication terminal through a web or a WAP.

In the application program for idle screen of the mobile communication terminal, synchronization is established between the service server for adding or deleting a template type and the mobile communication terminal at step S203. That is, if a user adds/deletes a template type using the mobile communication terminal, the application program of the mobile communication terminal transmits a template code corresponding to the template type to the service server, which then updates the service server.

Where the template type is selected using the web or WAP not the mobile communication terminal, the user transmits a template code for a template type, which has been selected to be added/deleted, to the service server. The service server updates a template code for each user and pushes the template code for the template type, which has been selected in a web or WAP, to the mobile communication terminal to add/delete the template type of the idle screen of the mobile communication terminal of the user. The mobile communication terminal then updates the template code.

If the user adds/deletes the idle screen template type of the mobile communication terminal, the template type is added/deleted in the application program. A channel set in the added/deleted template type is changed accordingly.

Determining whether each channel has been set depends on the added/deleted template type. As a result of the check, if the channel has not been set, a message for setting a channel is displayed.

Since the message is displayed as described above, the user can set a channel so that the desired information content can be allocated to the channel. The application program of the mobile communication terminal transmits a content code corresponding to the information content to the service server.

The service server can update a code for information content in the mobile communication terminal.

The service server configures a channel depending on a template type to be displayed on the idle screen of the mobile communication terminal. The service server forms information content for the configured channel as characters of SMS form and pushes the information content to the mobile communication terminal.

Through a series of these processes, a template type to be displayed on the idle screen of the mobile communication terminal is added/deleted and displayed at step S205.

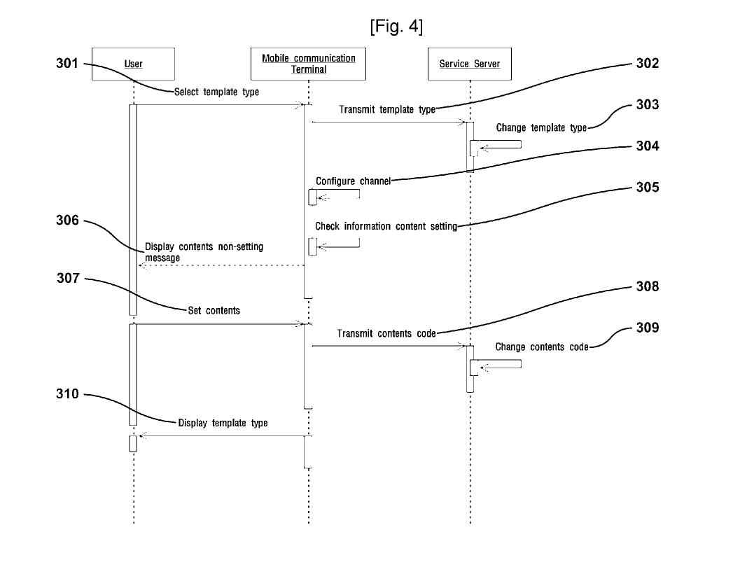

FIG. 4 is a sequence diagram showing a procedure for changing template types using an application program for the idle screen provided in the mobile communication terminal according to the present invention.

As shown in FIG. 4, a user selects any one of the template types, which have been previously set, to display it on the idle screen of the mobile communication terminal in the mobile communication terminal (301). The mobile communication terminal transmits a template code for the selected template type to the service server (302).

That is, a variety of template types have been prepared in the idle screen so that a user can easily identify them. The template codes exist as identification codes for identifying the variety of the template types. As a result, each template has its own template code, by using of those codes, the amount of data between the mobile communication terminal and the service server can be reduced.

The service server updates an existing template code with the received template code (303).

The mobile communication terminal configures a channel according to the template type selected by a user (304).

In the mobile communication terminal, a channel is allocated to each template type to be displayed on the idle screen.

A variety of information content is allocated to each channel. Information content is transmitted to the mobile communication terminal through the channel and is then displayed on the idle screen. As a result, if a user changes a template type, a channel is added or the number of channels is reduced. Information content is added or reduced along with the reduction or addition of channels. That is, a content code exists as an identification code for allocating information content to a channel.

To configure a channel, the application program for the idle screen of the mobile communication terminal checks whether the information content that should be configured in each channel has been correctly set (3011).

If a content code has not been allocated to a channel that is configured in the template type, a content code that is basically recommended by a service provider is allocated to a channel or the mobile communication terminal displays a message on the idle screen indicating that a user has not selected information content yet (306).

If the user wants to receive other information content, the user can select the desired information content from the information content list and set the information content to be received (307).

The mobile communication terminal transmits a content code corresponding to the information content, which is desired by the user, to the service server (3020). The service server analyzes the received content code and, then updates and changes the content code in the channel that is configured in the template type selected by the user (309).

By aforementioned sequence, then the application program for idle screen of the mobile communication terminal changes a template type to be displayed on the idle screen (310).

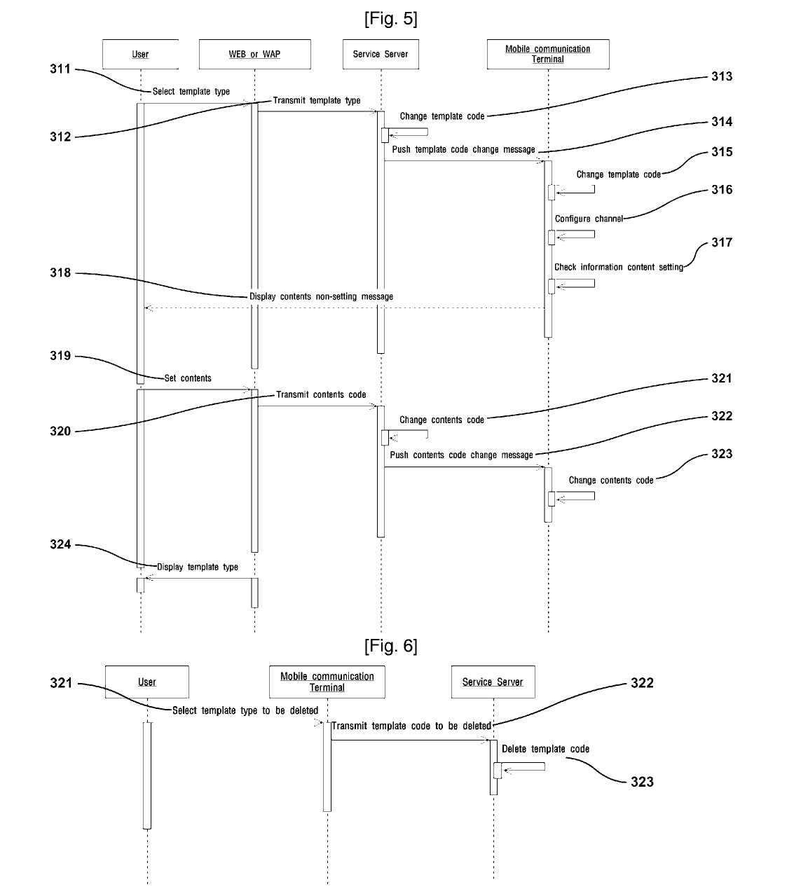

FIG. 5 is a sequence diagram showing a procedure of changing the template types to be displayed on the idle screen of the mobile communication terminal in a web or WAP according to the present invention.

As shown in FIG. 5, a user selects any one of predetermined template types to display the template on the idle screen of the mobile communication terminal in the mobile communication terminal (311). The web or WAP transmits a template code for the selected template type to the service server (312). The service server analyzes the received template code and updates a template code for each user, which is managed in the service server (313). After the template code is updated in the service server, the service server constructs characters in SMS form for indicating the change of the template type and pushes the constructed message to the mobile communication terminal (314).

The mobile communication terminal analyzes the SMS which is pushed from the service server and updates and changes the template code based on the analysis result (3111). The mobile communication terminal configures a channel depending on the template type selected by a user (316). In the mobile communication terminal, a channel is allocated to each template type to be displayed on the idle screen.

A variety of information content is allocated to each channel. Information content is transmitted to the mobile communication terminal through the channel and is then displayed on the idle screen. As a result, if a user changes a template type, a channel is added or the number of channel is reduced. Information content is added or reduced along with the reduction or addition of channels. That is, an information content code serves as an identification code for allocating information content to a channel.

To configure a channel, the application program for the idle screen of the mobile communication terminal checks whether information content that should be configured in each channel has been correctly set (317).

If a content code has not been allocated to a channel that is configured in the template type, a content code that is basically recommended by a service provider is allocated to a channel or the mobile communication terminal displays a message on the idle screen indicating that a user has not selected information content yet (3120).

If the user wants to receive other information content, the user can select the desired information content from the information content list displayed in the web or the WAP and set the information content to be received (319).

The web or WAP transmits a content code corresponding to the information content for content that the user wants to receive through the mobile communication terminal to the service server (320). The service server analyzes the received content code and, then updates and changes the content code in the channel that is configured in the template type selected by the user (321). After the content code is updated, the service server constructs the content code in SMS form and sends the constructed content code to the mobile communication terminal (322). The mobile communication terminal updates and changes the content code (323). The application program for idle screen of the mobile communication terminal changes a template type to be displayed on the idle screen (324).

FIG. 6 is a sequence diagram showing a procedure of deleting the template types using the application program for idle screen provided in the mobile communication terminal according to the present invention.

As shown in FIG. 6, a user selects a template type which of an idle screen template of the mobile communication terminal to be deleted (321).

*Template codes serve as identification codes for identifying various template types of the mobile communication terminal. Since a corresponding template code can be used for each template, the amount of data transmitted between the mobile communication terminal and the service server decreases.

The mobile communication terminal transmits a template code corresponding to the template type, which was selected by the user, to the service server (322). The service server deletes the aforementioned template type code from a template code list that is set by a user (323).

Through this process, a user can delete a template type stored in the mobile communication terminal.

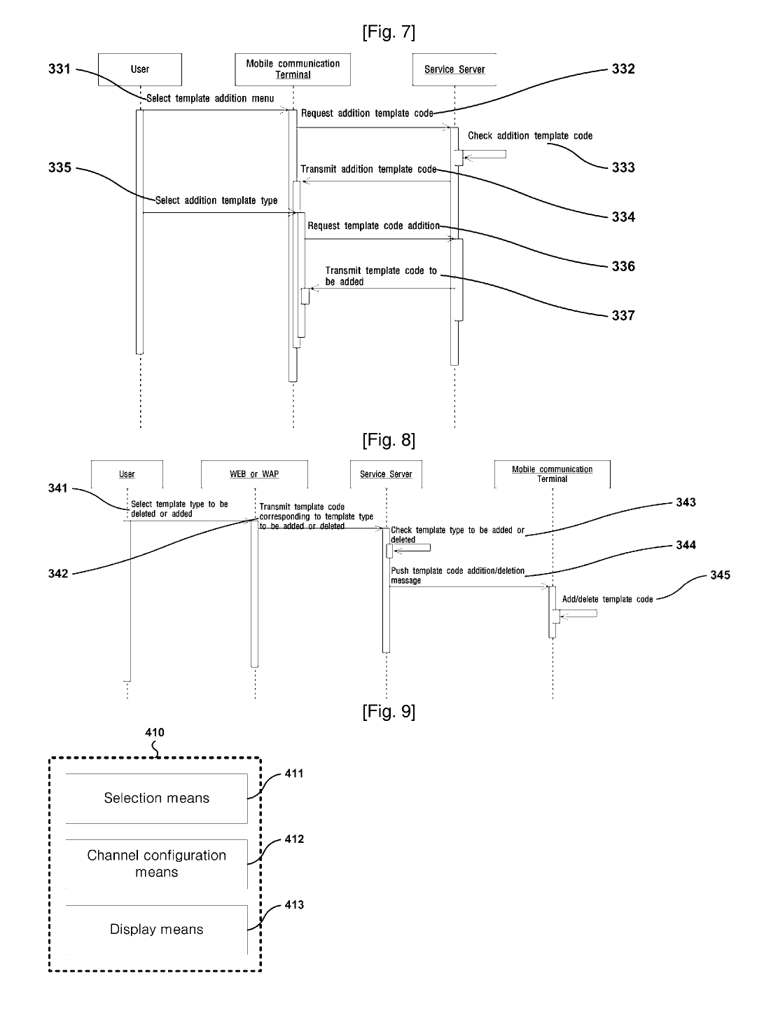

FIG. 7 is a sequence diagram showing a procedure of adding template types using the application program for the idle screen provided in the mobile communication terminal according to the present invention.

As shown in FIG. 7, to add an idle screen template, a user selects a template addition menu provided in the mobile communication terminal (331).

The mobile communication terminal connects with the service server then the mobile communication terminal requests an addition template code from the service server (332).

The service server determines whether there a template type can be added, by analyzing the request received from the mobile communication terminal (333). If a template type can be added, the service server sends the additional template code to the mobile communication terminal (334).

The service server does not transmit all template types that can be added to the mobile communication terminal, but transmits a preview screen through which a template type can be simply confirmed.

The user confirms the preview form of the template type and selects a template type to be added (3311).

The mobile communication terminal requests a template code to be added to the service server (336).

The service server transmits the template code to be added to the mobile communication terminal (337).

Through this process, the mobile communication terminal can be consistently supplied with a new template type from the service server.

FIG. 8 is a sequence diagram showing a procedure of adding/deleting template types to be displayed on the idle screen of the mobile communication terminal in the WEB or WAP according to the present invention.

As shown in FIG. 8, a user selects a template type that will be deleted or added from a web or WAP (341).

The web or WAP transmits a template code corresponding to the template type that the user wants to add or delete to the service server (342).

The service server determines whether there is any template type that can be added or deleted by analyzing a template addition or deletion request received from the web or WAP, to (343).

The service server constructs the template code, which has been added or deleted by the user in the web or WAP, in SMS form and pushes the constructed message to the mobile communication terminal (344).

The mobile communication terminal analyzes the messages pushed from the service server, and adds or deletes the template type of the mobile communication terminal based on the analysis result.

FIG. 9 is a block diagram of a mobile communication terminal comprising means for changing template types to be displayed on the idle screen of the mobile communication terminal according to the present invention.

As shown in FIG. 4, the mobile communication terminal 410 comprises selection means 411, channel configuration means 412 and display means 413.

The selection means 411 selects any one of template types that have been previously set to display the template type on the idle screen of the mobile communication terminal 410. The channel configuration means 412 configures a channel in accordance with the selected template type. The display means 413 displays the selected template type. That is, a user can select a template type of a mobile communication terminal using the selection means 411. The channel is configured to the selected template type and is allocated to information content by using the channel configuration means 412. A screen is configured to recognize information content by using the display means 413.

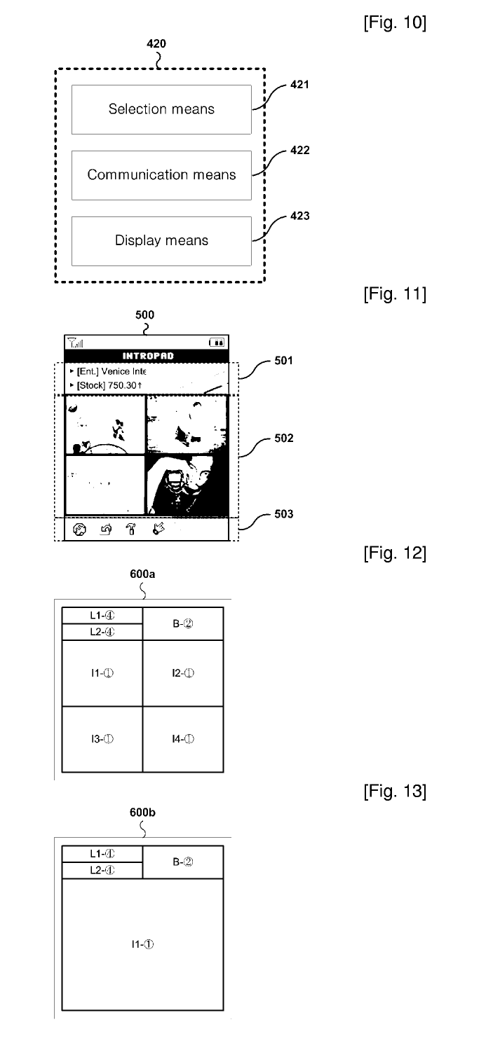

FIG. 10 is a block diagram of a mobile communication terminal comprising means for adding or deleting template types to be displayed on the idle screen of the mobile communication terminal according to the present invention.

As shown in FIG. 10, the mobile communication terminal 420 comprises selection means 421, communication means 422 and display means 423.

The selection means 421 can add or delete a template type. The communication means 422 gains access to the service server to add or delete the selected template type, and transmit or receive a template type code or a control code. The display means 423 can display a basic template type instead of the template type which is added or deleted. That is, a user can add or delete a template type of the mobile communication terminal using the selection means 421, communicate for adding or deleting the template type of the mobile communication terminal with the service server through the SMS service using the communication means 422, add or delete an idle screen template type of the mobile communication terminal using the display means 423, display the added template type, and construct a channel using a previously set template other than a deleted template type.

FIG. 11 is a block diagram showing basic elements constituting the idle screen of the mobile communication terminal according to the present invention.

As shown in FIG. 11, an idle screen 1100 of the mobile communication terminal comprises a sliding region 1101, a multimedia region 1102 and an icon region 1103.

The sliding region 1101 consists of basic two regions. In this region, data periodically slides from the right to the left in the sliding region 1101. In the sliding region 1101, real-time broadcasting (Data Push & Pull) text information is displayed or real-time advertisements or advertisement images slide.

The multimedia region 1102 can display 4 or more information content elements depending on a user' setting. In this case, however, displaying an excess amount of information content consumes too much power in the mobile communication terminal and the mobile communication terminal cannot support such power consumption.

Therefore, it is preferred that the multimedia region 1102 displays less than 4 information content elements in image form.

The icon region 1103 is provided to execute a main menu as small icon form. “The entire service-setting-live” and character types such as “CLR: upper” and “#:Information Storage” on the right of icon arrangements are displayed.

The focus in the idle screen 1100 is changed among the sliding region, the multimedia region and the icon region.

As a result, the sliding region 1101 and multimedia region 1102 are displayed as various types of the template types.

The template types will be described in detail with reference to FIGS. 12 to 17.

FIGS. 12 to 17 are block diagrams showing the template types to be displayed on the idle screen of the mobile communication terminal according to the present invention.

A template type shown in FIG. 12 is an idle screen template type of a four-division template (active) form.

As shown in FIG. 12, the four-division template type 600a is comprised of two sliding text regions (L1-\textcircled{4}, L2-\textcircled{4}), one sliding image region (B-\textcircled{2}) and four image regions (I1-\textcircled{1}, I2-\textcircled{2}, I3-\textcircled{1} and I4-\textcircled{1}).

A template type shown in FIG. 13 is an idle screen template type of the whole template (Easy View) form.

As shown in FIG. 13, the whole template type 600b consists of two sliding text regions (L1-\textcircled{4}, L2-\textcircled{4}), one sliding image region (B-\textcircled{2}) and one image region (I1-\textcircled{1}).

A template type of FIG. 14 is an idle screen template type of the whole template (Easy View) form.

As shown in FIG. 14, the sliding text template type 600c comprises eight sliding text regions (L1-\textcircled{1} to L20-\textcircled{1}) and one sliding image region (B-\textcircled{2}).

The sliding text template type 600c is a template type that is useful for a user who favors a simple information list such as news or stock information.

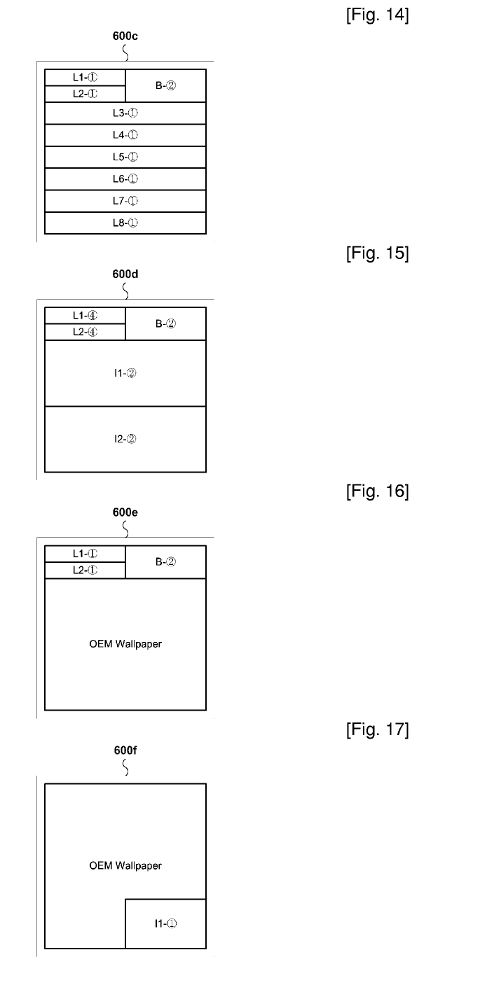

A template type of FIG. 15 is an idle screen template type of the two-division template (Couple) form.

As shown in FIG. 15, the two-division template type 600d includes two sliding text regions (L1-\textcircled{1}, L2-\textcircled{1}), one sliding image region (B-\textcircled{2}) and two image regions (I1-\textcircled{2}, I2-\textcircled{2}).

A template type of FIG. 16 is an idle screen template type of partial text template (Partial Text) form.

As shown in FIG. 16, the partial text template type 600e comprises two sliding text regions (L1-\textcircled{1}, L2-\textcircled{1}), one sliding image region (B-\textcircled{2}) and OEM wallpaper screen (OEM Wallpaper).

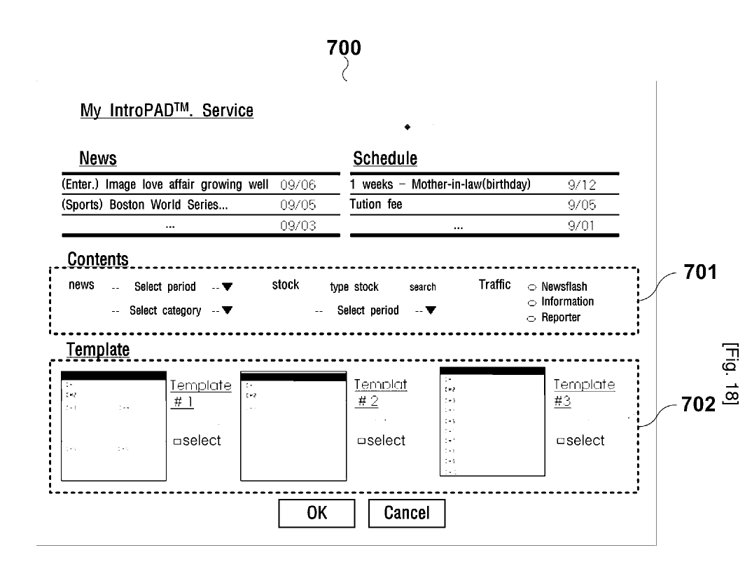

A template type of FIG. 17 is an idle screen template type of partial screen template (Partial Screen) form.

As shown in FIG. 17, the partial screen template type 600f is comprised of one image region (I1-\textcircled{1}) and OEM wallpaper screen (OEM Wallpaper).

FIG. 18 shows a WEB screen for changing the idle screen template types of the mobile communication terminal according to the present invention.

As shown in FIG. 18, the web screen 700 comprises a screen 701 for setting content and a screen 702 for setting template types.

In the screen 701 for setting information content, a variety of content for servicing the sliding region or the multimedia region is selected in the mobile communication terminal.

In the screen 702 for setting the template types, a variety of template types shown in FIGS. 12 to 17 are provided.

Because the channels set according to the template types are different from each other, the channel can be set by selecting the template types and then focusing the region.

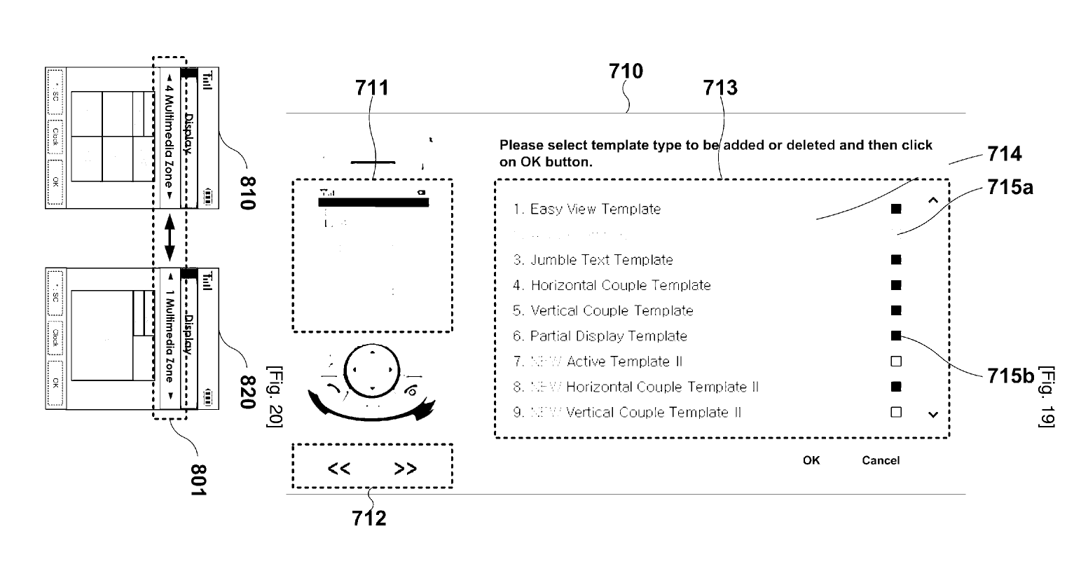

FIG. 19 shows a WEB screen for adding/deleting idle screen template types of the mobile communication terminal according to the present invention.

As shown in FIG. 19, the web screen 710 comprises a region 711 that template types can be previewed, and a template type list 713 that template types that can be individually configured and template types that can be added and viewed simultaneously.

A user can preview template types using a template type navigator 712. A user can easily recognize a type name of a template that is being previewed using a select bar 714.

A user can recognize whether a template type has been selected (7111b) or whether there is a template type to be newly added (7111a) at once.

That is, a user can easily add or delete a template type of the mobile communication terminal by selecting or releasing the combo boxes (7111a, 7111b) on which the template types can be selected.

FIG. 20 shows a template setting screen of a WAP or a mobile communication terminal for changing the idle screen template types of the mobile communication terminal according to the present invention.

As shown in FIG. 20, the template setting screen 2000 comprises a template select unit 2001 for selecting a template type at an upper side of the screen to set a template type. A variety of template types can be selected in the template select unit 2001 using a direction key or a key corresponding to the direction key.

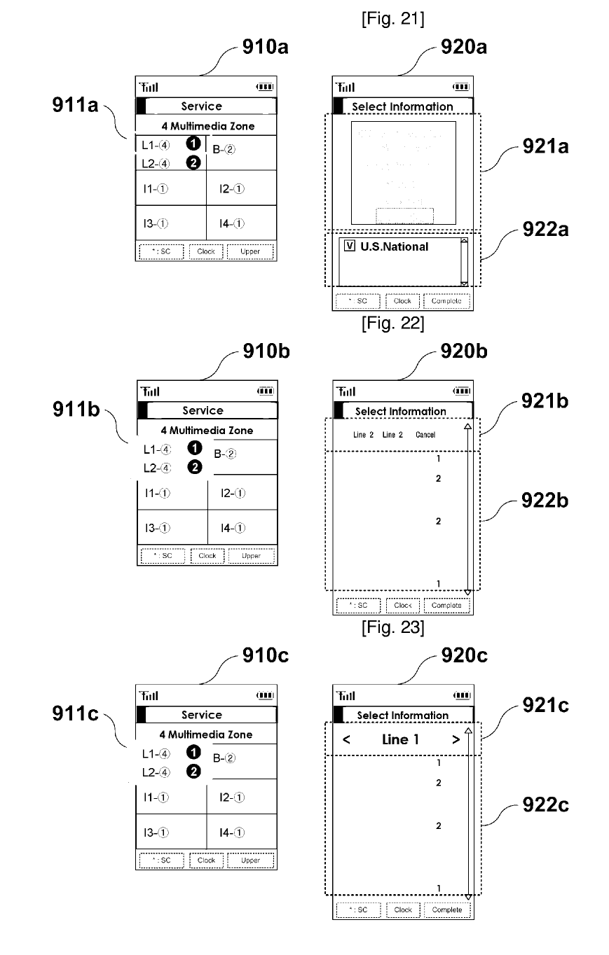

FIG. 21 illustrates an example of the allocation of information content to a channel that has been previously set in an idle screen template type of the mobile communication terminal according to the present invention.

As shown in FIG. 21, an information content setting screen 920a comprises a content list 921a that is being received to allocate content from service server and a content select unit 922.

That is, as described above with reference to FIG. 20, if a template type is selected and a channel 911a of a sliding region, which is allocated to the selected template type is selected in a template type setting screen 928 of the mobile communication terminal, for setting a template type, the procedure branches to the content setting screen 920a in which content can be selected.

Information content received in the mobile communication terminal is listed in the content setting screen 920a. The listed content is then displayed on a content list 921a.

In a content select unit 922, content can be added or deleted by selecting or canceling check boxes listed beside the content.

FIG. 22 illustrates an example of the allocation of content to a channel that has been previously set in an idle screen template type of the mobile communication terminal according to the present invention.

As shown in FIG. 22, a content setting screen 920b comprises a sliding region select unit 921b and a content select unit 923 for allocating received content.

That is, as described above with reference to FIG. 20, if a template type is selected and two sliding regions 911b allocated to the selected template type are selected at the same time in a template type setting screen 929 for setting a template type in the mobile communication terminal, the procedure branches to the content setting screen 920b in which content can be selected.

A sliding region select unit 921b for selecting one of the two sliding regions 911b is included in the content setting screen 920b. In the sliding region select unit 921b, content received in the mobile communication terminal is listed and then displayed on a content select unit 923.

If the content that can be selected is selected in the content select unit 923 and a channel is selected in the sliding region select unit 921b, a selected channel number is displayed on the list of the content select unit 923 along with the content list.

In the method of selecting a channel in the sliding region select unit 921b, the channel can be selected using a direction key or means corresponding to the direction key.

That is, content can be selected or cancelled by selecting content in the content select unit 923 and allocating a channel to be allocated to the selected content in the sliding region select unit 921b.

FIG. 23 illustrates an example of allocation of content to a channel that has been previously set in an idle screen template type of the mobile communication terminal according to the present invention.

As shown in FIG. 23, a content setting screen 920c comprises a sliding region select unit 921c, and a content select unit 922c for allocating content that is being received.

That is, as described above with reference to FIG. 20, if a template type is selected and two sliding regions 911c allocated to the selected template type are selected at the same time in a template type setting screen 910c for setting a template type in the mobile communication terminal, the procedure branches to the content setting screen 920c in which content can be selected.

A sliding region select unit 921c for selecting one of the two sliding regions 911c is included in the content setting screen 920c. Content that is being received in the mobile communication terminal is listed in the sliding region select unit 921b. The listed content is then displayed on a content select unit 923.

If the content that can be selected currently is selected in the content select unit 922c and a channel is selected in the sliding region select unit 921b, a selected channel number can be displayed on the list of the content select unit 922c along with the content list.

In the method of selecting a channel in the sliding region select unit 921c, the channel can be selected using a direction key or means corresponding to the direction key.

That is, content can be selected or cancelled by selecting content in the content select unit 922c and allocating a channel to be allocated to the selected content in the sliding region select unit 921c.

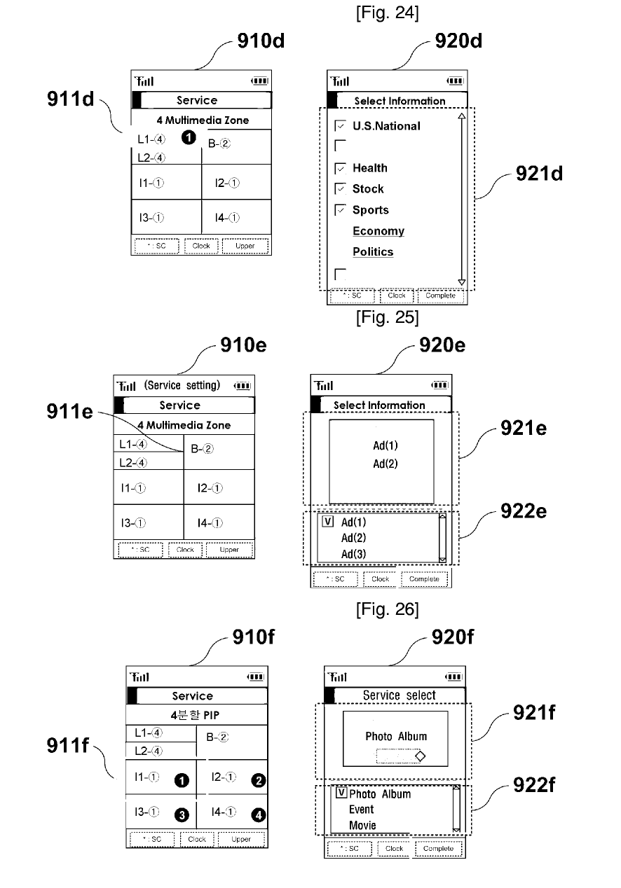

FIG. 24 illustrates an example of allocation of the content to a channel that has been previously set in an idle screen template type of the mobile communication terminal according to the present invention.

As shown in FIG. 24, a content setting screen 920d comprises a content select unit 921d for allocating content that is being received.

That is, as described above with reference to FIG. 20, if a template type is selected and a channel 911d of one sliding region, which is allocated to the selected template type, is selected in a template type setting screen 910d for setting a template type in the mobile communication terminal, the procedure branches to the content setting screen 920d in which content can be selected.

Content that is being received in the mobile communication terminal is listed in the content setting screen 920d. The listed content is then displayed on a content select unit 921d.

Check boxes are displayed on a content select unit 921d along with the list of the content select unit.

That is, content can be selected or cancelled by selecting or canceling the check box in the content select unit 921d.

FIG. 25 illustrates an example of the allocation of content to a channel that has been previously set in an idle screen template type of the mobile communication terminal according to the present invention.

As shown in FIG. 25, a content setting screen 920e comprises a content list 921e, and a content select unit 922e for allocating content that is being received.

That is, as described above with reference to FIG. 20, if a template type is selected and a channel 911e of one sliding region, which is allocated to the selected template type, is selected in a template type setting screen 910e for setting a template type in the mobile communication terminal, the procedure branches to the content setting screen 920e in which content can be selected.

Content that is being received in the mobile communication terminal is listed in the content setting screen 920e. The listed content is then displayed on the content list 921e. Content can be added or deleted by selecting or canceling content in the content select unit 922e.

FIG. 26 illustrates an example of the allocation of content to a channel that has been previously set in an idle screen template type of the mobile communication terminal according to the present invention.

As shown in FIG. 25, a content setting screen 920f comprises a content list 921e, and a content select unit 922f for allocating content that is being received.

That is, as described above with reference to FIG. 20, if a template type is selected and a channel 911f of one sliding region, which is allocated to the selected template type, is selected in a template type setting screen 910f for setting a template type in the mobile communication terminal, the procedure branches to the content setting screen 920f in which content can be selected.

Content that is being received in the mobile communication terminal is listed in the content setting screen 920f. The listed content is then displayed on the content list 921f. Content can be added or deleted by selecting or canceling content in the content select unit 922f.

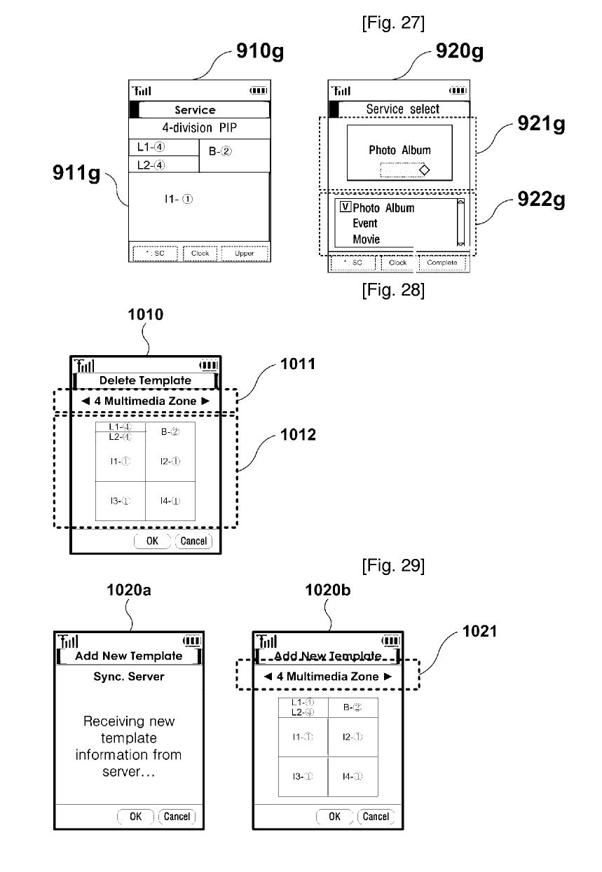

FIG. 27 illustrates an example of the allocation of content to a channel that has been previously set in an idle screen template type of the mobile communication terminal according to the present invention.

As shown in FIG. 27, a content setting screen 920g comprises a content list 921g, and a content select unit 922g for allocating content that is being received.

That is, as described above with reference to FIG. 20, if a template type is selected and a channel 911g of one sliding region, which is allocated to the selected template type, is selected in a template type setting screen 910g for setting a template type in the mobile communication terminal, the procedure branches to the content setting screen 920g in which content can be selected.

Content that is being received in the mobile communication terminal is listed in the content setting screen 920g. The listed content is then displayed on the content list 921g. Content can be added or deleted by selecting or canceling content in the content select unit 922g.

FIG. 28 illustrates an example of deleting idle screen template types of the mobile communication terminal according to the present invention.

As shown in FIG. 28, if a user of the mobile communication terminal uses a template type delete menu provided in the mobile communication terminal, the process branches to a template type delete screen 1010 of the mobile communication terminal.

If a template type is selected (1011), a template preview screen 1012 appears. A template type can be deleted by clicking on a confirmation button.

This process has been described in detail with reference to FIG. 6.

FIG. 29 illustrates an example of adding the idle screen template types of the mobile communication terminal according to the present invention.

As shown in FIG. 29, if a user of the mobile communication terminal uses a template type add menu provided in the mobile communication terminal, the process branches to a template type add screen 1020a of the mobile communication terminal.

The mobile communication terminal is connected to the service server and requests the service server to check an additional template type to know whether the template type can add.

After a preview for confirming a template type that can be added is downloaded to the mobile communication terminal, the user can search using a navigation bar 1021 to confirm what template type can be added and add a new template type by clicking on a confirmation button.

This process has been described in detail with reference to FIG. 7.

### INDUSTRIAL APPLICABILITY

The present invention provides a method of changing templates of an idle screen in a mobile communication terminal so that a user can configure the idle screen of the mobile communication terminal to his taste.

The present invention provides a method of changing templates of an idle screen in a web or WAP so that a user can configure the idle screen of the mobile communication terminal to his taste.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A method of changing an idle screen template type of a mobile communication terminal, comprising the steps of:
(a) accepting a template type which is selected from any one of template types by user;
(b) configuring a channel according to the accepted template type;
(c) changing a template type in accordance with the accepted template type in which the channel is configured.

2. A computer-readable recording medium in which a program for executing a method of changing an idle screen template type of a mobile communication terminal in a computer, the method comprising the steps of:
(a) accepting a template type which is selected from any one of template types by user;
(b) configuring a channel according to the accepted template type;
(c) changing a template type in accordance with the accepted template type in which the channel is configured.

3. The computer-readable recording medium as claimed in claim 2, wherein the selection of the template type in the step (a) is performed using a template type change application program within the mobile communication terminal or through a web or a Wireless Application Protocol (WAP).

4. The computer-readable recording medium as claimed in claim 3, wherein the template type is selected using the application program, a template type code corresponding to the changed template type is transmitted to a service server.

5. The computer-readable recording medium as claimed in claim 3, wherein the template type is selected through the web or WAP, a template type code corresponding to the changed template type is transmitted from the service server to the mobile communication terminal.

6. The computer-readable recording medium as claimed in claim 2, wherein the method further comprises the steps of: after the step (b),
(b-1) determining whether information content has been allocated in each of the configured channels; and
(b-2) if it is determined that information content has not been allocated in the step (b-1), allocating the desired information content to a channel.

7. The computer-readable recording medium as claimed in claim 6, wherein in the step (b-2), the desired information content can be allocated by selecting the information content that has already been received within the mobile communication terminal.

8. The computer-readable recording medium as claimed in claim 7, wherein the information content is transmitted or received as a content code.

9. The computer-readable recording medium as claimed in claim 2, wherein the channel included in the selected template type is a sliding region in which characters or images are displayed while being moved, or a multimedia region in which images or motion picture is displayed.

10. A mobile communication terminal in which an idle screen template type can be changed, comprising:
selection means for selecting any one of template types that have been previously set to display the selected template type on an idle screen;
channel configuration means for configuring a channel according to the selected template type;
template type change means for changing a template type that is already displayed to a changed template type in accordance with the template type in which the channel is configured by the channel configuration means; and
display means for displaying the changed template type on the idle screen.

11. The mobile communication terminal as claimed in claim 10, wherein the selection of the template type is performed using a template type change application program within the mobile communication terminal or through a web or a WAP.

12. The mobile communication terminal as claimed in claim 11, wherein the template type is selected using the application program, a template type code corresponding to the changed template type is transmitted to a service server.

13. The mobile communication terminal as claimed in claim 11, wherein the template type is selected through the web or WAP, a template type code corresponding to the changed template type is transmitted from the service server to the mobile communication terminal.

14. The mobile communication terminal as claimed in claim 10, comprising:
channel check means for determining whether information content has been set in each of the configured channels; and
channel allocation means for allocating desired information content so that the desired information content can be set in a channel, if it is determined that information content has not been set by the channel check means.

15. The mobile communication terminal as claimed in claim 14, wherein the desired information content is received from the service server by requesting the desired information content to the service server, or allocated by selecting the information content that has already been received within the mobile communication terminal.

16. The mobile communication terminal as claimed in claim 15, wherein information content that is requested to the service server is transmitted as a content code.

17. The mobile communication terminal as claimed in claim 10, wherein the channel included in the selected template type is a sliding region in which characters or images are displayed while being moved, or a multimedia region in which a images or a motion picture is displayed.

18. A method of adding or deleting an idle screen template type of a mobile communication terminal, comprising the steps of:
(a) adding or deleting template types displayed on an idle screen of the mobile communication terminal by user;
(b) communicating with a service server to add or delete a selected template type; and
(c) configuring an idle screen of the mobile communication terminal depending on the result of the addition or deletion of the template type, and displaying the configured idle screen,
wherein the addition or deletion of the template type in the step (a) is performed using a template type change application program within the mobile communication terminal or through a web or a WAP.

19. The method as claimed in claim 18, further comprising the steps of: after the step (b),
(b-1) determining whether any template type to be added or deleted exists in a service server; and
(b-2) after the step (b-1), transmitting template type information, which will be added or deleted in an idle screen template type change program of the mobile communication terminal, to the service server.

20. The method as claimed in claim 19, further comprising the steps of: after the step (b-2),
(b-21) determining whether the deleted template type is a current idle screen template type; and
(b-22) configuring the information content so the information content is allocated to a channel according to the basic template types other than the deleted template type, depending on the result of the step (b-21).
